(19) United States
(12) Patent Application Publication
(10) Pub. No.: US 2025/0130928 A1
(43) Pub. Date: Apr. 24, 2025

(54) AUTOMATED GENERATION OF TEST CODE FOR TESTING EMBEDDED SOFTWARE

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Stuttgart (DE)

(21) Appl. No.: 18/885,814

(22) Filed: Sep. 16, 2024

(30) Foreign Application Priority Data
Sep. 28, 2023 (EP) 23200609.8

(51) Int. Cl. G06F 11/3668

(52) U.S. Cl. CPC G06F 11/3684; G06F 11/3688; G06F 11/3696

(57) ABSTRACT

A computer-implemented method for the automated generation of test code for testing software. The method includes generating, via a machine learning model, at least one test case and/or a test code at least based on a code of the software and a prompt; and evaluating the at least one test case and/or the test code, wherein an evaluation result is obtained. A computer-implemented method for further training a machine learning model and/or further machine learning model is also described. The machine learning model configured to generate at least one test case and/or a test code for testing software at least based on a code of the software and a prompt, and the further machine learning model is designed to generate a test code for testing the software at least based on at least one test case and a further prompt.

### BACKGROUND INFORMATION

Embedded software for controlling, regulating and/or monitoring technical systems, in particular cyber-physical systems, such as the processing units of a vehicle and/or a robot, is usually highly complex. As a result, it is challenging for individual software engineers and even entire software development departments to maintain an overview of software and its changes, in particular throughout its entire life cycle (development, testing, production and maintenance).

Software can be prone to errors and must therefore be tested thoroughly throughout its life cycle. Particularly problematic are errors or vulnerabilities that—apart from the functionality of the software—impair or even jeopardize the security of the software, i.e. the technical system it controls, regulates and/or monitors. Therefore, software testing is often integrated into a formalized validation and verification (V & V) process.

For example, software can be tested for errors using static and/or dynamic software tests, wherein static software tests, unlike dynamic software tests, do not execute the software. Test cases and/or test code can be defined for testing the software. Despite the support of some tools, the creation of test cases and/or test code is still predominantly manual work. Test cases can, for example, define the inputs to and expected outputs from a function of the software. A test code can implement the test cases and thus makes them executable. The tools usually aim to fulfill a certain test coverage (e.g., instruction coverage, path coverage, etc.), i.e. that certain parts of the software code are executed. However, these tools have so far worked purely on the syntax of the code to be tested, without knowing the actual underlying requirements (i.e., the specification of the software). As a result, they always systematically create the same quantity of test cases and/or test code. The code to be tested can be executed using the generated test code, but the correctness of executing usually has to be ensured by manual asserts. With regard to the complexity of the software, a higher degree of automation would also be desirable.

The present invention addresses the problem of automatically yet reliably providing better test cases and/or test code for testing the software.

### SUMMARY

A first general aspect of the present invention relates to a computer-implemented method for the automated generation of test code for testing software. According to an example embodiment of the present invention, the method comprises generating, via a machine learning model, at least one test case and/or test code based at least on a code of the software and a prompt. The method further comprises evaluating the at least one test case and/or the test code, wherein an evaluation result is obtained.

The software can be designed to control, regulate and/or monitor a technical system, in particular a cyber-physical system, in particular at least one computing unit of a vehicle. In particular, the software can be embedded software. The method can be performed in an electronic programming environment. The method can comprise executing the test code, optionally as a function of the evaluation result, wherein the software is tested.

A second general aspect of the present invention relates to a computer-implemented method for further training a machine learning model and/or further machine learning model, wherein the machine learning model is designed to generate at least one test case and/or a test code for testing software at least based on a code of the software and a prompt, and the further machine learning model is designed to generate a test code for testing the software at least based on at least one test case and a further prompt. According to an example embodiment of the present invention, the method comprises adapting the machine learning model and/or further machine learning model at least based on at least one test case and/or the test code and on at least one evaluation result, wherein the at least one evaluation result is obtained by evaluating the at least one test case and/or the test code. The method according to the second general aspect (or an embodiment thereof) can, but need not, be performed according to the method according to the first general aspect (or an embodiment thereof).

A third general aspect of the present invention relates to a computer system that is designed to perform the computer-implemented method for the automated generation of test code for testing software according to the first general aspect (or an embodiment thereof) and/or the computer-implemented method for further training a machine learning model and/or further machine learning model according to the second general aspect (or an embodiment thereof).

A fourth general aspect of the present invention relates to a computer program that is designed to perform the computer-implemented method for the automated generation of test code for testing software according to the first general aspect (or an embodiment thereof) and/or the computer-implemented method for further training a machine learning model and/or further machine learning model according to the second general aspect (or an embodiment thereof).

A fifth general aspect of the present invention relates to a computer-readable medium or signal that stores and/or contains the computer program according to the fourth general aspect (or an embodiment thereof).

The method disclosed herein, according to the first aspect (or an embodiment thereof), is directed to the automated generation of test code for testing the software. The high degree of automation allows for the software to be tested on the basis of a (large) number of test cases and/or test code. The method according to the present invention can be used to generate meaningful test cases and/or more meaningful test code, or at least more meaningful test cases compared to the results of conventional tools. This is achieved, on the one hand, by the machine learning model with a sufficiently large machine language understanding and, on the other hand, by the automated evaluation of the test cases and/or the test code according to established V & V methods. As a result, machine creativity of the machine learning model can be used, while at the same time the quality of the test cases and/or test code can be secured. In other words: errors, in particular faulty test cases and/or faulty test code, which can occasionally arise due to the machine learning model, are reliably or at least with a sufficiently high probability recognized by the V & V methods before they are used for testing the software. As a result, only error-free test cases and/or error-free test code are used to test the software. As a result, the functionality and security of the software and, for example, the technical systems controlled, regulated and/or monitored by the software, such as a vehicle or a robot, can be improved. The high degree of automation also makes it possible to examine many more test cases when testing the software. As a result, the software and therefore the technical system can be improved.

An advantage is that, in contrast to conventional methods, not only the syntax but also all other available information from the software code (such as natural language comments) can be used to generate test cases, which leads to test cases that are more meaningful than systematically generated test cases. Advantageously, further meta information (e.g., requirements from a natural language and/or formal specification) can also be included in the generation of the test cases and/or the test code.

In particular, the variability (e.g., through random selection) in the output of the machine learning model (which can be referred to as temperature in technical jargon) can generate many different test cases/code, which can lead to higher test coverage (e.g., in terms of scenarios)—beyond the test coverage that can be evaluated using traditional test coverage measures. For example, this can more easily lead to repeated triggering of a control, in order to, e.g., reach the stop. Due to the large amount of training data on which the (trained) machine learning model is based, a great deal of experience of how test cases should look for the relevant case is incorporated into the generation. Thus, the generation is better adapted to the relevant context than with previous (algorithmic) methods, which can only use the context to a very limited extent, since all cases would have to be explicitly taken into account. Due to the assert of the generated test cases and/or the generated test code with formal methods, it is ensured that the test cases and/or the test code are correct and meet predetermined quality criteria. In particular, errors can be recognized and corrected, e.g. in the assert of the results (in the test code).

The method according to present invention can also be used in order to supplement an existing set of test cases and/or existing test code with additional test cases, e.g. to fulfill a different purpose and/or cover other aspects. In addition, existing test cases and/or test code that have not been evaluated sufficiently well can be adapted, improved and/or corrected in further iterations of the method. In this respect, it can also be advantageous to initially only generate and evaluate test cases and only then generate the test code(s), for example in a further iteration of the method.

The method of the present invention can not only generate the function call with corresponding parameters, but can also generate test code for checking the result (which may be corrected in the next step).

The method of the present invention is equally applicable to all common programming languages and does not have to be laboriously adapted to a specific programming language or newly developed, as was previously the case.

The test cases and/or the test code can also be generated in particular for automatically translated code (e.g., from C to Rust). As a result, the translation of the code can be validated and/or verified.

A further advantage is that the resulting test cases and/or test codes can be used in order to train a domain-specific test code generator. This can be effected, for example, as in the method 200 according to the second general aspect (or an embodiment thereof). As a result, supervised fine-tuning and/or unsupervised (reinforcement) learning can be carried out based on the evaluation results, and thus the method according to the first general aspect (or an embodiment thereof) can be improved. As a result, it will be possible to generate even better test cases and/or test code for testing the software in the future.

### BRIEF DESCRIPTION OF THE DRAWINGS

FIG. 1A schematically illustrates exemplary embodiments of a computer-implemented method for the automated generation of test code for testing software, according to the present invention.

FIG. 1B schematically illustrates exemplary embodiments of a computer-implemented method according to the present invention for the automated generation of test code for testing software, wherein at least one test case is generated.

FIG. 1C schematically illustrates exemplary embodiments of a computer-implemented method according to the present invention for the automated generation of test code for testing software, wherein the test code is generated.

FIG. 1D schematically illustrates exemplary embodiments of a computer-implemented method according to the present invention for the automated generation of test code for testing software, wherein initially at least one test case and then the test code are generated.

FIG. 2 schematically illustrates exemplary machine learning models according to the present invention that map at least code and prompt to at least one test case and/or the test code.

FIG. 3A-3B schematically illustrate the evaluation of the at least one test case and/or test code, according to an example embodiment of the present invention.

FIG. 4 schematically illustrates the testing of the software by executing the test code in an execution environment, according to an example embodiment of the present invention.

### DETAILED DESCRIPTION OF EXAMPLE EMBODIMENTS

The method 100 of the present invention disclosed herein is directed to the automated generation of test code for testing software. The software can be designed to control, regulate and/or monitor a technical system, in particular a cyber-physical system, in particular at least one computing unit of a vehicle. In particular, the software can be embedded software designed to be executed on an embedded (i.e., for example, task-specific) system.

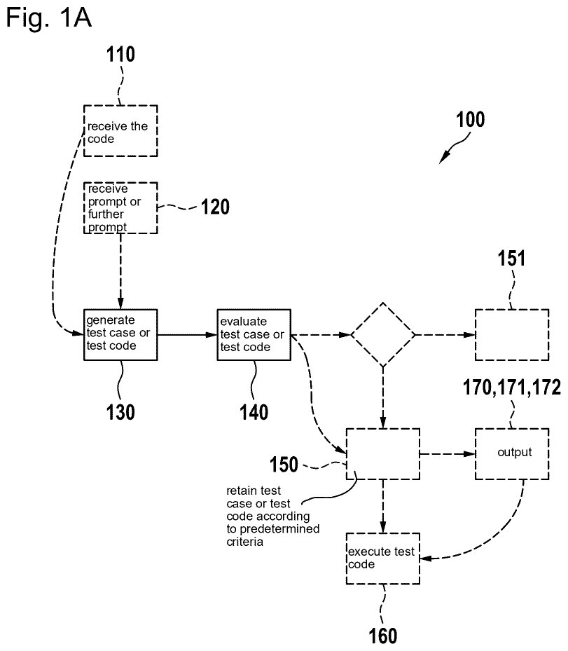

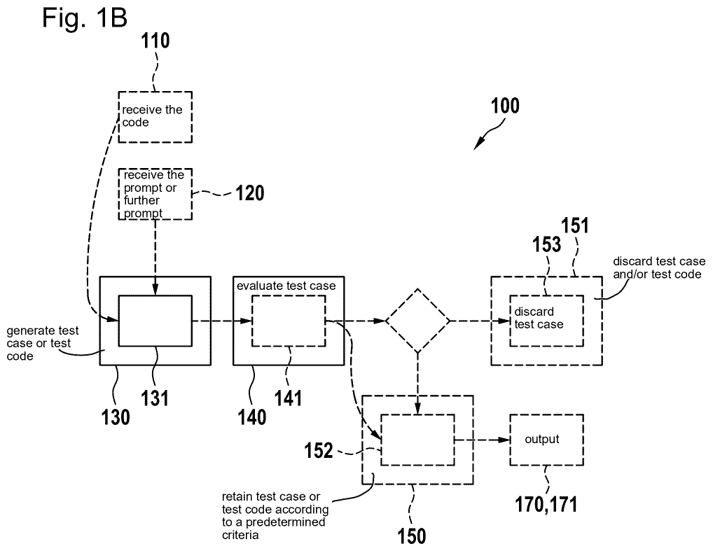

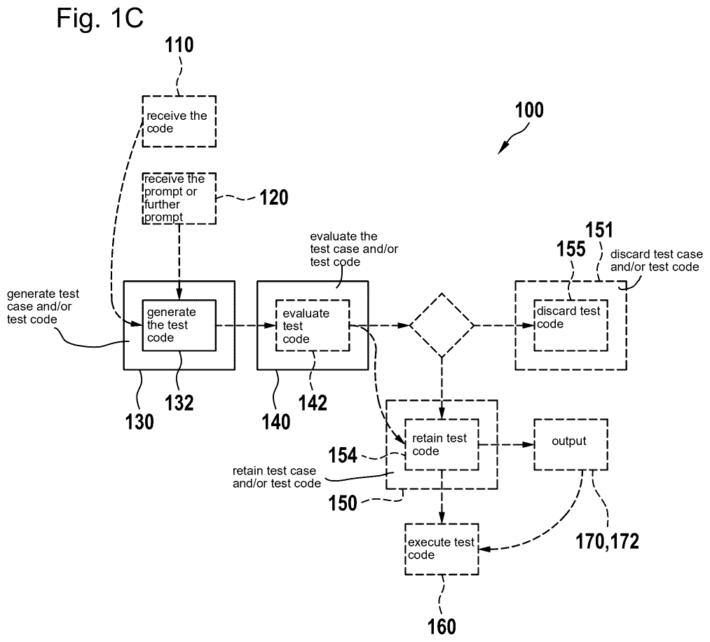

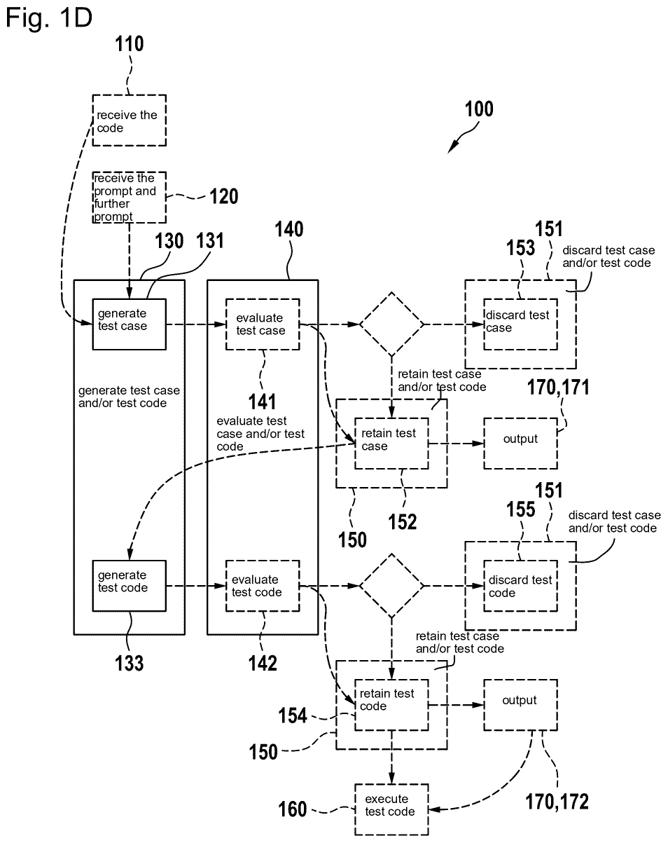

Disclosed for this purpose is initially a computer-implemented method 100, such as schematically illustrated in FIG. 1A-1D, for the automated generation of test code for testing software. The method 100 comprises generating 130, via a machine learning model 30, at least one test case 40 and/or a test code 50 at least based on a code 10 of the software and a prompt 20. The method 100 further comprises evaluating 140 the at least one test case 40 and/or the test code 50, wherein an evaluation result is obtained.

The method 100, such as schematically illustrated in FIG. 1B, can comprise, for example, generating 130, 131, via the machine learning model 30, the at least one test case 40 (i.e., not necessarily the test code) at least based on the code 10 of the software and the prompt 20, and evaluating 140, 141 the at least one test case 40, wherein an evaluation result is obtained. In another example, such as schematically illustrated in FIG. 1C, the method 100 can comprise generating 130, 132, via the machine learning model 30, the test code 50 (i.e., not necessarily the at least one test case) based at least on the code 10 of the software and the prompt 20, and evaluating 140, 142 the test code 50, wherein an evaluation result is obtained. Furthermore, the method 100 can also comprise, as for example schematically illustrated in FIG. 1D, generating 130, 131, 132, via the machine learning model 30, the at least one test case 40 and the test code 50 at least based on the code 10 of the software and the prompt 20, and evaluating 140, 141, 142 the at least one test case 40 and/or the test code 50, wherein an evaluation result is obtained.

The code 10 of the software can be a source code of the software. The code 10 can be written in one or more programming languages. For example, the code 10 can be written in the C programming language. Alternatively or additionally, the code 10 can be written in the Rust programming language, for example. Thanks to the sufficiently large language understanding of the machine learning model, no specification regarding the programming language(s) need be effected. In other words, the method 100 can be applied to any code regardless of the programming language or languages.

The at least one test case 40 can, for example, comprise a natural language text or be such a natural language text. Alternatively or additionally, the at least one test case can comprise a data structure written in a predetermined syntax (e.g., in a programming language) or can be such a data structure. The data structure can, for example, comprise the natural language text. The at least one test case can describe a scenario of how the code (in particular when it is executed) or the software is to be tested. For example, the at least one test case can define one or more input variables on which the code or software is to be executed. The at least one test case can also define one or more reference output variables that are expected when executing the code or software.

The test code 50 can be an executable code. As a result, the software can be tested automatically within the framework of validation and verification (V & V). The test code can be designed to test the software with regard to (the) at least one test case. In particular, the test code can be designed to be executed in an execution environment 70 (test harness), such that the code 10 of the software is also executed, i.e. tested, at least partially (namely, at least to the extent required by the test case) in the execution environment 70. This is shown schematically in FIG. 4.

The machine learning model 30 can comprise or be a foundation model. A foundation model can be a large machine learning model that has been trained on a large dataset at scale (often through self-supervised learning or semi-supervised learning) so that it can be adapted to a wide range of downstream tasks. In particular, the machine learning model can comprise or be a large language model (LLM). A large language model can be a language model that is characterized by its size. In particular, the large language model can be a chatbot and/or have chatbot functionality.

Meta AI LLAMA, for example, can be used as a large language model. Such a large language model can be advantageous since it and in particular its weights and/or biases can be adapted, for example by the method 200. Alternatively or additionally, Google BERT can be used, for example. Alternatively or additionally, for example, OpenAI's ChatGPT (e.g. in the version of May 24, 2023) can be used as a large language model. Alternatively or additionally, for example, Hugging Face Bloom can be used as a large language model.

Alternatively or additionally, the machine learning model can comprise or be a multi-domain model. For example, OpenAI's GPT-4 (e.g. the version of Mar. 14, 2023) can be used here.

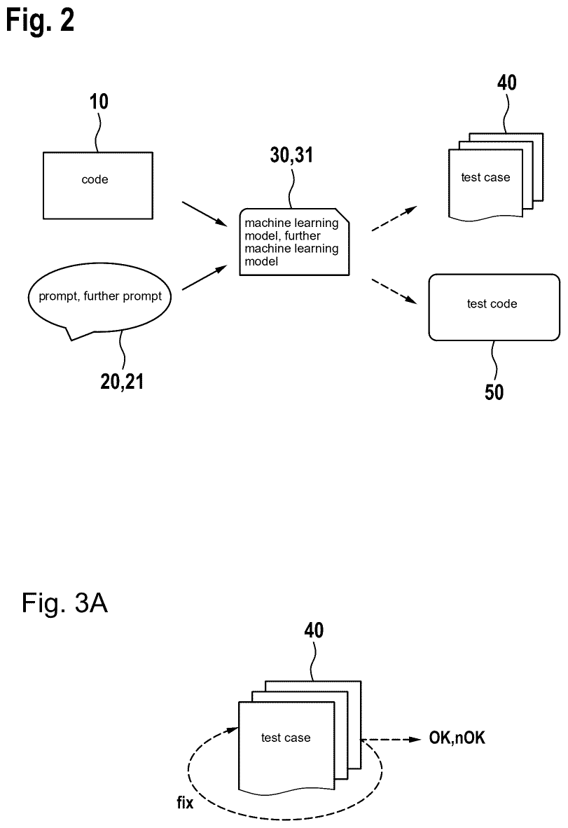

Exemplary embodiments of the machine learning model 30 are schematically illustrated in FIG. 2.

The prompt 20 can be a natural language text. The prompt 20 can comprise or be a natural language instruction to the machine learning model 30. The prompt can, for example, comprise a linguistic instruction to the large language model (LLM) directed to generating at least one test case for testing the code. Alternatively or additionally, the prompt can comprise, for example, a linguistic instruction to the large language model (LLM) directed to generating at least one test code for testing the code. In particular, the prompt can comprise, for example, a linguistic instruction to the large language model (LLM) directed to generating at least one test case and at least one test code, in each case for testing the code.

Alternatively or additionally, the prompt can comprise a linguistic instruction to the large language model (LLM) directed to how similar to and/or different from the at least one predetermined test case the at least one test case is to be generated. Alternatively or additionally, the prompt can comprise a linguistic instruction to the large language model (LLM) directed to how similar to and/or different from the at least one predetermined test case the at least one test code is to be generated. In particular, the prompt can comprise a linguistic instruction to the large language model (LLM) directed to how similar to and/or different from the at least one predetermined test case the at least one test case and the at least one test code is to be generated.

Alternatively or additionally, the prompt can comprise a linguistic instruction to the large language model (LLM) directed to how similar to and/or different from at least one test case encoded in the at least one predetermined test code the at least one test case is to be generated. Alternatively or additionally, the prompt can comprise a linguistic instruction to the large language model (LLM) directed to how similar to and/or different from at least one test case encoded in the at least one predetermined test code the at least one test code is to be generated. Alternatively or additionally, the prompt can comprise a linguistic instruction to the large language model (LLM) directed to how similar to and/or different from at least one test case encoded in the at least one predetermined test code the at least one test case and the at least one test code is to be generated.

The method 100 can comprise generating a plurality of test cases 40 (i.e., at least two test cases). For example, one or more test cases of the plurality of test cases can be generated at least based on the code and the prompt, i.e. in a (single) execution of the method 100. Alternatively or additionally, one or more test cases of the plurality of test cases can be generated by multiple executions of the method 100. Advantageously, the prompt can be varied in multiple executions of the method 100. On the other hand, the prompt does not have to be varied in multiple executions of the method 100. Alternatively or additionally, one or more test cases can be predetermined. Alternatively or additionally, the machine learning model can be varied in multiple executions of the method 100.

The method 100 can comprise generating a plurality of test codes 50 (i.e., at least two test codes). Alternatively or additionally, the method 100 can comprise generating a test code that is designed to test the software with regard to a plurality of test codes.

The method 100 can comprise receiving 110 the code 10. Alternatively or additionally, the method 100 can comprise receiving 120 the prompt 20 and/or the further prompt 21, wherein the order of the steps 110 and 120 can be irrelevant. Alternatively or additionally, the method 100 can comprise receiving the machine learning model 30 and/or the further machine learning model 31.

The evaluation result can comprise a natural language text or be such a natural language text. Alternatively or additionally, the evaluation result can comprise or be a data structure written in a predetermined syntax (e.g., in a programming language). The data structure can, for example, comprise the natural language text. The evaluation result can comprise one or more numerical values, in particular one or more confidence values. As a result, a quality of the at least one test case and/or the test code can be coded, which can be taken into account during the validation and verification (V & V) of the software.

If it is not possible to generate a test case and/or test code, the evaluation result can comprise information that the generation of at least one test case and/or the test code has failed. This can happen, for example, if the code is already contradictory. This information is also valuable for the development of the technical system. In this case, the code can and must be adapted and, in particular, improved.

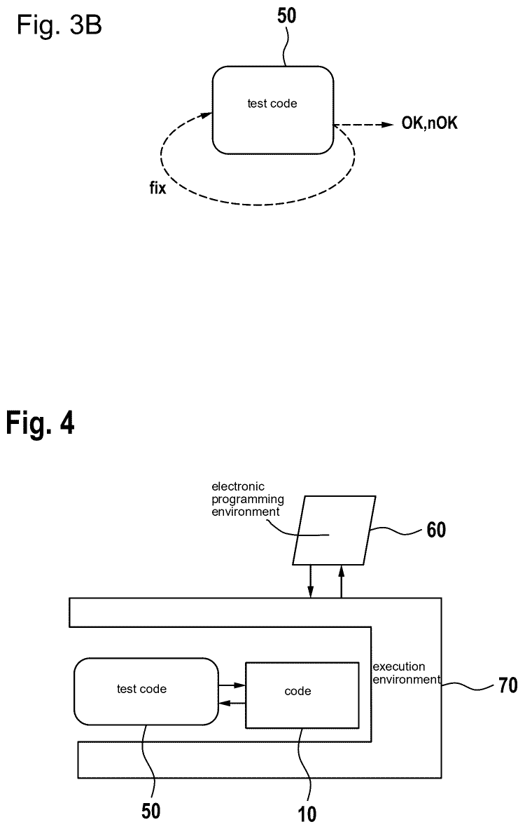

As shown schematically, e.g., in FIG. 3A-3B, the at least one test case 40 and/or the test code 50 can be evaluated, wherein, for example, in each case the results OK or nOK (short for: not OK) are comprised in the evaluation result. In the event of an nOK result, the at least one test case 40 and/or the test code 50 can be repaired (“fixed” or “fix”), wherein a test case and/or test code generated in a previous iteration of the method 100 can be adapted, improved and/or corrected, for example, in a further iteration of the method 100.

The method 100 can be performed in an electronic programming environment 60. The electronic programming environment 60 can, but need not, be the execution environment 70. The electronic programming environment can be superordinate to the execution environment, as shown schematically, e.g., in FIG. 4. For example, the execution environment can be initialized and then controlled by the electronic programming environment. Furthermore, for example, one or more execution results can be returned from the execution environment to the electronic programming environment. The electronic programming environment allows for programming and/or interaction with a plurality of iterations of the method 100. The electronic programming environment proves to be particularly advantageous when initializing the iterations and/or debugging during the iterations.

By adapting the (further) prompt 20, 21 accordingly, the execution environment for testing the software can also be generated by the (further) machine learning model 30, 31. In general, the prompt 20 and/or the further prompt 21 can be adapted in the electronic programming environment, for example.

Specific factors on which the generation of test cases and/or test code can depend are disclosed below.

The generation 130 of the at least one test case and/or the test code can be based at least on a natural language comment in the code of the software. This is advantageous, since critical passages in the code in particular are often (well) commented. As a result, the software can be tested at these critical points in particular.

Alternatively or additionally, the generation 130, via the machine learning model, of the at least one test case and/or the test code can be based on at least one predetermined test case (or on a plurality of predetermined test cases). The at least one predetermined test case can, for example, be taken into account as further input of the machine learning model when generating 130 the at least one test case and/or the test code. Alternatively, the at least one predetermined test case can be included in the generation 130 of the at least one test case and/or the test code via the prompt. The at least one predetermined test case can, but need not, be obtained from an earlier iteration of the method 100. Depending on the prompt, predetermined test cases can be extended, improved and/or corrected by a further iteration of the method 100.

Alternatively or additionally, the generation 130, via the machine learning model 30, of the at least one test case and/or the test code can be based on at least one predetermined test code (or on a plurality of predetermined test codes). The at least one predetermined test code can, for example, be taken into account as further input of the machine learning model when generating 130 the at least one test case and/or the test code. Alternatively, the at least one predetermined test code can be included in the generation 130 of the at least one test case and/or the test code via the prompt. The at least one predetermined test code can, for example, be written in the same programming language as the code. The at least one predetermined test code can, but need not, be obtained from an earlier iteration of the method 100. Depending on the prompt, test cases coded in a predetermined test code can be extended, improved and/or corrected by a further iteration of the method 100.

Alternatively or additionally, the generation 130, via the machine learning model, of the at least one test case and/or the test code can be based on meta information of the code. In particular, the meta information can comprise or be a (natural language) description of the code. Alternatively or additionally, the meta information can comprise or be a (natural language or formal) specification of the code, i.e. the software. The meta information can, for example, be taken into account as further input of the machine learning model when generating 130 the at least one test case and/or the test code. Alternatively, the meta information can be included in the generation 130 of the at least one test case and/or the test code via the prompt. Both the description of the code and the specification can comprise software objectives to be achieved. This information can prove particularly useful when it comes to thoroughly testing the functionality of the software. Furthermore, both the description of the code and the specification can comprise validity limits for parameters that make it possible to define particularly meaningful boundary tests.

The method 100 can comprise, as schematically illustrated for example by the “OK” in FIG. 3A-3B, retaining 150 the at least one test case and/or the test code according to a predetermined criterion based on the evaluation result. The method 100 can (but need not) comprise discarding 151 the at least one test case and/or the test code otherwise (i.e., if no retaining 150 is effected), as illustrated schematically, e.g., in FIG. 1A-1D. Instead of discarding, the at least one test case and/or the test code can, for example, be repaired, see e.g. FIG. 3A-3B.

The following discusses embodiments of the method 100 in which the at least one test case is generated 130, 131. As illustrated schematically, e.g., in FIG. 1B, this can be the case if only the at least one test case is generated 131 and (at least in this iteration of the method 100) no test code is generated 132. That is, the test code can then be generated 130, 132 in a further iteration of the method 100. On the other hand, this can also be the case if, as illustrated schematically, e.g., in FIG. 1D, both the at least one test case and the test code are generated 131, 132.

The at least one test case can then (but need not) be evaluated 140, 141, wherein an initial evaluation result is obtained. On the other hand, in embodiments as schematically illustrated in FIG. 1D, in which a test code is also generated 133, it can be sufficient to evaluate only the generated 133 test code 142. For example, evaluating 140, 141 the at least one test case can comprise checking whether the at least one test case is already known as a predetermined test case (e.g., in a plurality of predetermined test cases). The evaluation result can comprise or be the first evaluation result.

The method 100 can comprise retaining 152 the at least one test case according to a predetermined criterion based on the first evaluation result. As illustrated schematically, e.g., in FIG. 1B and FIG. 1D, the method 100 can (but need not) comprise discarding 153 the at least one test case otherwise (i.e., if no retaining 152 is effected). For example, the at least one test case can be discarded 153 if it is already known as a predetermined test case. Generally, a plurality of test cases are generated by the method 100 (e.g., also by multiple executions of the method) 130, 131. By discarding 153 at least one test case, retained 152 test cases are weighted more heavily in the multitude of test cases. If the scope of the test is always finite (here, especially if the test time is finite), the software test is improved by discarding 153 test cases that are not meaningful. As an alternative to discarding 153, the at least one test case can, for example, be extended, improved and/or corrected.

The following discusses embodiments of the method 100 in which the test code is generated 130, 132. As illustrated schematically, e.g., in FIG. 1C, this can be the case if only the test code is generated 132 and (in this iteration of the method 100) no test cases are generated 131. Here, for example, the test code can be generated 130 via the machine learning model, at least based on the code of the software and the prompt. In other words, here, for example, the test code can be generated without a previously generated at least one test case 130, 132. Here, for example, at least one test case can be an intermediate result that is not output by the machine learning model.

On the other hand, this can also be the case if, as illustrated schematically, e.g., in FIG. 1D, both the at least one test case (here as an intermediate step that can also be output) and the test code are generated 131, 132.

Namely, the method can comprise generating 133, via a further machine learning model 31, a test code 50 at least based on the at least one test case 40 and a further prompt 21, wherein the test code 50 is designed to test the software with regard to the at least one test case 40 (or the plurality of test cases). This procedure can be advantageous, for example, because at least one test case can be evaluated before the test code is generated.

The further machine learning model 31 can comprise or be a foundation model. In particular, the additional machine learning model can comprise or be a large language model (LLM). Alternatively or additionally, the further machine learning model can comprise or be a multi-domain model. As illustrated schematically, e.g., in FIG. 2, the further machine learning model 31 can, but need not, be the machine learning model 30.

The other prompt 21 can be a natural language text. The further prompt 21 can comprise or be a natural language instruction to the machine learning model 31. The further prompt can comprise a linguistic instruction to the large language model (LLM) directed to generate one or more test codes for testing the code based on the at least one test case.

The test code can then be evaluated 140, 142, wherein a second evaluation result is obtained. The evaluation result can comprise or be the second evaluation result. For example, the evaluation result can comprise the first and second evaluation results.

The method 100 can comprise retaining 154 the test code according to a predetermined further criterion based on the second evaluation result. As illustrated schematically, e.g., in FIG. 1C and FIG. 1D, the method 100 can (but need not) comprise discarding 155 the test code otherwise (i.e., if no retaining 154 is effected). For example, the test code can be discarded 155 if it is already known as a predetermined test code. A plurality of test codes can be generated by the method 100 (e.g., including by performing the method multiple times) 130, 132. By discarding 155 the test code, retained 154 test codes are weighted more heavily in the plurality of test codes. If the scope of the test is always finite (here, especially if the test time is finite), the testing of the software is thus improved by discarding 155 test codes that are not meaningful. As an alternative to discarding 155 the test code, it can be extended, improved and/or corrected, for example.

Evaluating 140, 142 the test code 50 (and/or the method 100) can comprise executing the test code 50, wherein an execution result, e.g., an actual result of a called function, is obtained. This can be effected, as shown schematically, e.g., in FIG. 4, in an execution environment 70, wherein the code is executed in the execution environment, at least to the extent required by the at least one test case and/or the test code. The evaluation 140, 142 of the test code 50 (and/or the method 100) can further comprise checking whether the execution result matches a reference result (e.g., comprising one or more reference outputs) in the test code. Evaluating 140, 142 the test code 50 (and/or the method 100) can further comprise correcting the at least one test case and/or the test code, in particular the reference result, if the execution result does not match the reference result in the test code. Instead of correcting the at least one test case and/or the test code, or if the at least one test case and/or the test code cannot be corrected, the at least one test case and/or the test code can, for example, be discarded 153, 155, i.e. not used when testing the software. Alternatively or additionally, a new application of the method 100 can be based on the at least one test case and/or the test code and, optionally, the prompt can be adapted.

Alternatively or additionally, evaluating 140, 142 the test code (or the method 100) can comprise executing the test code 50. In turn, this can be effected in the execution environment 70, wherein the code is executed in the execution environment, at least to the extent required by the at least one test case and/or the test code. Evaluating 140, 142 the test code (or the method 100) can comprise measuring a code coverage when executing the code. Evaluating 140, 142 the test code (or the method 100) can comprise checking whether the code coverage is sufficiently large. Code coverage is often measured not just for one test case, but for a plurality of test cases. Depending on the issue, however, measuring the code coverage can also be useful for at least one test case or for a small number of test cases. By evaluating 140, 142 the test code in this way, the test case(s) in the test code can also be implicitly evaluated. In this respect, it may not be necessary to evaluate at least one test case 141.

Alternatively or additionally, evaluating 140, 142 the test code (or the method 100) can comprise a dynamic assert for redundancy of the test code (or the plurality of test codes). The dynamic assert for redundancy is often measured for the plurality of test cases. Depending on the issue, however, the dynamic assert for redundancy can also be useful for at least one test case or for a small number of test cases. Evaluating 140, 142 the test code can also implicitly evaluate the test case(s) in the test code.

Alternatively or additionally, evaluating 140, 142 the test code (or the method 100) can comprise measuring a suitability of the test code (or the plurality of test codes). This can be based on mutation testing. With mutation testing, for example, the code can be mutated in such a way that the (previous) execution result is changed. With mutation testing, there can be a check of whether the unchanged test code detects the changed code. As a result, the test code can be tested. At the same time, the suitability of the test case(s) in the test code can be measured. The suitability can indicate whether the test code is suitable for finding errors in the code.

The relevant test results can be coded in the second evaluation result.

The method 100 can comprise executing 160 the test code, wherein the software is tested with regard to (the) at least one test case. Executing 160 the test code can be effected depending on the evaluation result, in particular depending on the second evaluation result. For example, executing 160 the test code can be made dependent on the evaluation result and/or the second evaluation result having been evaluated as sufficiently good (“OK”) 140, 142. Here, the code, i.e. the software, can now be tested. As a result, the software, and therefore the technical system it controls, regulates and/or monitors, can be improved. The method 100 can comprise outputting 170 the evaluation result. This can be effected via the electronic programming environment, for example.

Outputting 170 the evaluation result can comprise outputting the first evaluation result. The first evaluation result can be output via the electronic programming environment, for example. The first evaluation result can comprise one or more results of evaluating 140, 141 the at least one test case. Alternatively or additionally, outputting 170 the evaluation result can comprise outputting the second evaluation result. The second evaluation result can be output via the electronic programming environment, for example. The second evaluation result can comprise one or more results of evaluating 140, 142 the test code. In particular, the second evaluation result can comprise, for example, a measured code coverage when executing the code of the software and, optionally, an evaluation of whether this is sufficiently large. Alternatively or additionally, the second evaluation result can comprise, for example, the measured suitability of the test code (e.g., based on mutation testing).

In particular, both the first and second evaluation results can be output via the electronic programming environment, for example. This is advantageous because the process flow of the method 100 can be adapted based on the evaluation result. For example, test cases and/or test code(s) can be manually selected or rejected based on the initial evaluation results.

Alternatively or additionally, the method 100 can comprise outputting 171 the at least one test case (or the plurality of test cases). This can be effected via the electronic programming environment.

Alternatively or additionally, the method 100 can comprise outputting 172 the test code. This can also be effected via the electronic programming environment.

The method 100 can be based on at least one input from a user of an interface of the electronic programming environment. For example, the method 100 and/or its multiple executions can be controlled (interactively) via the electronic programming environment. This can be helpful, for example, when configuring the programming environment and/or the execution environment before the method 100 is run automatically. Alternatively or additionally, the interactive control can be helpful in debugging the automated run of the method 100.

Alternatively or additionally, for example, one or more reference output variables can be supplemented and/or corrected via an input.

Alternatively or additionally, an interactive selection of the desired test cases can be effected via an input after the test case generation, for example, before continuing with the test code generation.

The method 100 can be repeated. The machine learning model and/or the prompt and, optionally, other inputs can be varied. If required, e.g. if the code coverage is too low and/or too few effective test cases or generally too few test cases have been generated, additional test cases can be generated in at least one further iteration, in particular to increase the coverage. The previous test cases, e.g., can be used as additional input.

Different test cases or test code can be generated by both single and multiple executions of the method 100. Even in a simple execution of the method 100, there is a variance due to the inherent variability of the machine learning model (temperature). For example, if it is to generate 101 different test cases on the basis of a prompt, 101 different test cases can actually be generated thanks to the inherent variability. There is also variance in multiple executions of the method 100 due to the possible variety of prompts. Alternatively or additionally, there is variance due to different combinations of different input artifacts (e.g., signature only, with implementation, with specification requirements, etc.). If statically determinable multiple test cases are generated (for example, by independent multiple executions), they can be rejected. Even if they are not rejected, they only affect the efficiency of the software test, but not the quality of the software test itself.

Further disclosed is a computer-implemented method 200 for further training a machine learning model 30 and/or a further machine learning model 31, wherein the machine learning model 30 is designed to generate 130 at least one test case 40 and/or a test code 50 in each case for testing software at least based on a code 10 of the software and a prompt 20, and, optionally, the further machine learning model 31 is designed to generate 133 a test code 50 for testing the software at least based on at least one test case 40 and a further prompt 21. The method 200 comprises adapting the machine learning model 30 and/or further machine learning model 31 at least based on at least one test case 40 and/or the test code 50 and on at least one evaluation result, wherein the at least one evaluation result is obtained by evaluating 140 the at least one test case 40 and/or the test code 50.

In particular, a computer-implemented method 200 for further training a machine learning model 30 is disclosed, wherein the machine learning model 30 is designed to generate 130 at least one test case 40 and/or a test code 50 in each case for testing software at least based on a code 10 of the software and a prompt 20. The method 200 comprises adapting the machine learning model 30 at least based on at least one test case 40 and/or the test code 50 and on at least one evaluation result, in particular on at least one first and/or second evaluation result, wherein the at least one evaluation result, in particular the at least one first and/or second evaluation result, is obtained by evaluating 140 the at least one test case 40 and/or the test code 50.

Alternatively or additionally, a computer-implemented method 200 for further training a further machine learning model 31 is disclosed, wherein the further machine learning model 31 is designed to generate 133 a test code 50 for testing the software at least based on at least one test case 40 and a further prompt 21. The method 200 comprises adapting the further machine learning model 31 at least based on at least one test case 40 and/or the test code 50 and on at least one evaluation result, in particular on at least one first and/or second evaluation result, wherein the at least one evaluation result, in particular the at least one first and/or second evaluation result, is obtained by evaluating 140 the at least one test case 40 and/or the test code 50.

Alternatively or additionally, a computer-implemented method 200 for further training a machine learning model 30 and a further machine learning model 31 is disclosed, wherein the machine learning model 30 is designed to generate 130 at least one test case 40 and/or a test code 50 in each case for testing software at least based on a code 10 of the software and a prompt 20, and the further machine learning model 31 is designed to generate 133 a test code 50 for testing the software at least based on at least one test case 40 and a further prompt 21. The method 200 comprises adapting the machine learning model 30 and/or further machine learning model 31 at least based on at least one test case 40 and/or the test code 50 and on at least one evaluation result, in particular on at least one first and/or second evaluation result, wherein the at least one evaluation result, in particular the at least one first and/or second evaluation result, is obtained by evaluating 140 the at least one test case 40 and/or the test code 50.

Evaluating 140 can, but need not, be part of the method 200. The at least one test case 40 and/or the test code 50 may have been generated 130 and evaluated 140 according to the method 100 for the automated generation of test code for testing software. The method 200 can, but need not, be a continuation of the method 100.

Alternatively or additionally, the method 100 can be newly performed via an adapted machine learning model and/or an adapted further machine learning model. In particular, the machine learning model 30 and/or the further machine learning model 31 can be adapted between multiple executions of the method 100 according to the method 200.

The adapting of the machine learning model 30 can be based on at least one code 10 to be tested and at least one prompt 20. Alternatively or additionally, the adapting of the further machine learning model 31 can be based on at least one test case 40 and a further prompt 21.

The machine learning model 30 and/or the further machine learning model 31 can be adapted by supervised learning. Such an adapting of the machine learning model 30 and/or the further machine learning model 31 can be regarded as supervised fine-tuning. Thanks to fine-tuning, a generic machine learning model that has been trained to understand a general machine language, for example, can be adapted to specific applications, i.e. here with regard to generating test cases and/or test code for testing the software.

The fine-tuning of the machine learning model 30 and/or the further machine learning model 31 can, but need not, be preceded by further adapting of the machine learning model 30 and/or the further machine learning model 31 by unsupervised (reinforcement) learning.

Alternatively or additionally, adapting the machine learning model 30 and/or further machine learning model 31 at least based on at least one test case 40 and/or the test code 50 and on at least one evaluation result can comprise calculating at least one reward at least based on the at least one evaluation result and adapting the machine learning model 30 and/or further machine learning model 31 at least based on the at least one test case 40 and/or the test code 50 and on the at least one reward. Such an adapting of the machine learning model 30 and/or the further machine learning model 31 can be regarded as unsupervised (reinforcement) learning. As a result, a generic machine learning model that has been trained to understand a general machine language, for example, and/or such a model after fine-tuning, can be (further) adapted to specific applications, i.e. here with regard to generating test cases and/or test code for testing the software. As a result, the machine learning model 30 and/or the further machine learning model 31 can be adapted even better to the use case of generating test cases and/or test code.

A reward can be a parameter, in particular a numerical parameter, that is comparable to other parameters that are also rewards. For example, a reward can be bigger, the same or smaller than another reward.

The at least one reward can be higher if the at least one evaluation result is better, and the at least one reward can be lower if the at least one evaluation result is worse.

An evaluation result can be worse, in particular bad, if an assert on which the evaluation result is based has already been negative, i.e. has not been passed, for example. Alternatively or additionally, an evaluation result can be better, in particular good, if all asserts are positive, i.e. passed, for example.

The machine learning model 30 and/or the further machine learning model 31 can be adapted based on at least a plurality of test cases 40 and/or test code 50 and a plurality of associated rewards. The method here can comprise calculating the rewards based at least on a plurality of evaluation results per test case 40 and/or test code 50 of the plurality of test cases 40 and/or test code 50. In other words, the reward for a test case or test code need not depend solely on its evaluation result, but can also be based on one or more evaluation results for other test cases and/or other test codes. For example, one or more rewards (i.e., the amount of the same) can depend on a number of evaluation results. Alternatively or additionally, one or more rewards can depend on a number of better evaluation results and on a number of worse evaluation results, in particular on an imbalance between better and worse evaluation results. Alternatively or additionally, rewards can initially be calculated per evaluation result and then adapted and/or offset based on other evaluation results.

The adapting of the machine learning model 30 and/or further machine learning model 31 can be based on a reinforcement learning algorithm, such as proximal policy optimization (PPO).

A part of the machine learning model 30 and/or a part of the further machine learning model 31 cannot (intentionally) be adapted, i.e. fixed. Here, only another part of the machine learning model 30 and/or a part of the other machine learning model 31 is adapted.

For example, certain parameters, such as weights and/or biases, in particular weights and/or biases on earlier layers of the machine learning model 30 and/or the further machine learning model 31, cannot be adapted, i.e. fixed. For example, the adaptations can be limited to back layers of the machine learning model 30 and/or the further machine learning model 31 in which test cases and/or test code are generated. As a result, it can be ensured that the machine learning model 30 and/or the further machine learning model 31 does not deteriorate excessively with regard to machine language comprehension. On the other hand, a degradation of the machine language understanding can be sought by adapting to the extent that it plays no role in generating test cases and/or test code for testing the software. For example, machine language understanding of Shakespearean English is not (usually) required for generating test cases and/or test code.

The method 200 can be controlled via the electronic programming environment 60. In particular, the machine learning model 30 and/or the further machine learning model 31 can be further adapted via the electronic programming environment.

Also disclosed is a computer system designed to perform the computer-implemented method 100 for the automated generation of test code for testing software. Alternatively or additionally, the computer system can be designed to perform the computer-implemented method 200 for further training a machine learning model 30 and/or further machine learning model 31. In particular, the computer system can be designed to execute the computer-implemented method 100 for automatically generating test code for testing software and to (e.g., subsequently) perform the computer-implemented method 200 for further training a machine learning model 30 and/or further machine learning model 31. The computer system can comprise a processor and/or a working memory.

Also disclosed is a computer program designed to perform the computer-implemented method 100 for the automated generation of test code for testing software. Alternatively or additionally, the computer program can be designed to perform the computer-implemented method 200 for further training a machine learning model 30 and/or further machine learning model 31. In particular, the computer program can be designed to execute the computer-implemented method 100 for automatically generating test code for testing software and to (e.g., subsequently) perform the computer-implemented method 200 for further training a machine learning model 30 and/or further machine learning model 31. The computer program can be present, for example, in interpretable or in compiled form. For execution, it can (even in parts) be loaded into the RAM of a computer, for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

1-15. (canceled)

16. A computer-implemented method for the automated generation of test code for testing software, comprising the following steps:
generating, via a machine learning model, at least one test case and/or a test code, at least based on a code of the software and a prompt; and
evaluating the at least one test case and/or the test code, wherein an evaluation result is obtained.

17. The method according to claim 16, wherein the software is configured to control and/or regulate and/or monitor a technical system, the technical system including a cyber-physical system including at least one computing unit of a vehicle.

18. The method according to claim 16, wherein the method is performed in an electronic programming environment.

19. The method according to claim 16, further comprising:
retaining the at least one test case and/or the test code according to a predetermined criterion based on the evaluation result; and
optionally, discarding the at least one test case and/or the test code otherwise.

20. The method according to claim 16, further comprising:
generating, via a further machine learning model, a test code at least based on the at least one test case and a further prompt, wherein the test code is configured to test the software with regard to the at least one test case.

21. The method according to claim 16, wherein the evaluating of the test code includes:
executing the test code, wherein the code of the software is executed in an execution environment, at least to the extent required by the at least one test case and/or the test code, wherein an execution result is obtained;
checking whether the execution result matches a reference result in the test code; and
optionally, correcting the at least one test case and/or the reference result, when the execution result does not match the reference result in the test code.

22. The method according to claim 16, wherein the evaluating of the test code includes:
executing the test code, wherein the code of the software is executed in the execution environment, at least to the extent required by the at least one test case and/or the test code;
measuring a code coverage when executing the code of the software;
checking whether the code coverage is sufficiently large.

23. The method according to claim 16, wherein the evaluating of the test code includes a dynamic assert for redundancy of the test code.

24. The method according to claim 16, wherein the evaluating of the test code includes:
measuring suitability of the test code based on mutation testing.

25. The method according to claim 16, further comprising:
executing the test code, optionally depending on the evaluation result, wherein the software is tested.

26. A computer-implemented method for further training a machine learning model and/or further machine learning model, wherein the machine learning model is configured to generate at least one test case and/or a test code for testing software at least based on a code of the software and a prompt, and the further machine learning model is configured to generate a test code for testing the software at least based on at least one test case and a further prompt, the method comprising the following steps:
adapting the machine learning model and/or the further machine learning model at least based on at least one test case and/or the test code, and at least one evaluation result, wherein the at least one evaluation result is obtained by evaluating the at least one test case and/or the test code;
wherein the at least one test case and/or the test code has been generated and evaluated according to a method for automated generation of test code for testing the software, the method for automated generating including:
generating, via the machine learning model, the at least one test case and/or the test code, at least based on a code of the software and a prompt, and
evaluating the at least one test case and/or the test code, wherein the evaluation result is obtained.

27. The method according to claim 26, wherein the adapting of the machine learning model and/or the further machine learning model at least based on the at least one test case and/or the test code and on the at least one evaluation result includes:
calculating at least one reward at least based on the at least one evaluation result; and
adapting the machine learning model and/or the further machine learning model at least based on the at least one test case and/or the test code, and based on the at least one reward.

28. A computer system configured to automated generation of test code for testing software, the computer system configured to:
generate, via a machine learning model, at least one test case and/or a test code, at least based on a code of the software and a prompt; and
evaluate the at least one test case and/or the test code, wherein an evaluation result is obtained.

29. A non-transitory computer-readable medium on which is stored a computer program for automated generation of test code for testing software, the computer program, when executed by a computer, causing the computer to perform the following steps:
generating, via a machine learning model, at least one test case and/or a test code, at least based on a code of the software and a prompt; and
evaluating the at least one test case and/or the test code, wherein an evaluation result is obtained.
